(19) United States
(12) Patent Application Publication
(10) Pub. No.: US 2013/0117644 A1
(43) Pub. Date: May 9, 2013

(54) GENERATING AND PRINTING TARGET PAGE NUMBERS OVER LINKS WHILE PRINTING DOCUMENTS OR WEB PAGES

(71) Applicants: Anmol Dhawan, Ghaziabad (IN); Sachin Soni, New Delhi (IN); Sachin Gaur, Ghaziabad (IN); Ganesh Sahai, Noida (IN)

(72) Inventors: Anmol Dhawan, Ghaziabad (IN); Sachin Soni, New Delhi (IN); Sachin Gaur, Ghaziabad (IN); Ganesh Sahai, Noida (IN)

(21) Appl. No.: 11/687,633

(22) Filed: Mar. 17, 2007

(51) Int. Cl. G06F 17/22

(52) U.S. Cl. CPC G06F 17/2235
USPC 715/205

(57) ABSTRACT

A method and system for generating information related to links in a document by preprocessing the document for at least one link within the document followed by modifying content of the document such that the modified content includes information related to at least one link within the document in an augmented format and displaying the modified document. Embodiments of the invention relate to generating and printing target page numbers over internal links appearing in a document or web page to indicate physical location of the links in the same document or web page. Embodiments of the invention also generate and print hyperlinks over external links, pointing to some external document or html page, appearing in a document or web page. Embodiments of the invention relate to generating and printing information relating to an action link appearing in a printed document.

### BACKGROUND

1. Technical Field

The description relates to generating and printing target page information above internal links, external links and action links appearing in a document or web page.

2. Prior Art

When a user is browsing a document using Adobe® Acrobat® or any other browser and encounters internal links, external links or action links within the document, it is easy to click on the links and automatically access the target page. However, problems arise when the user desires to print a document containing links. In that case, the links merely appear as printed information and the problems associated therewith are manifold.

First, in case of internal links (i.e., whose target is present in the same document or html file), the exact location of a particular link within the same document or file must be determined manually by the user. For example, say a user is browsing a document containing an internal link to the term “prior art” in the first page of the document and decides to print out the document. The print out will merely contain this link without any indication as to the location of the link within the document. The user will then need to scan the document manually to determine the exact location of the link. This could be a laborious process for documents in general and for lengthy documents in particular.

Second, problems arise when a user browses a document containing an external link. For example, if a user is browsing a document containing an external link such as “Adobe Systems Incorporated” the printout will merely contain this link without any information as to the hyperlink that this link is targeting.

Third, under existing prior art techniques, printing a document containing action links is also problematic. Action links are links appearing in an html document or pdf file that perform different actions including, but not limited to, opening a file, opening a web link, playing a sound and so on. Existing techniques provide for the user to manually assign different colors or grayscales to represent each individual action link. However, in following this approach, if the user, for some reason, fails to manually assign colors for the different links, the user will be unable to identify the action for the link in a printed document. Even when colored, details about the action link can not be ascertained by seeing the action link in print.

### SUMMARY

An HTML or PDF link target can perform many different actions such as opening a file, opening a weblink, or playing a sound. Embodiments of the invention described herein provide a method and system for generating, displaying and printing target page number over internal links appearing in a document or web page to indicate physical location of the links in the same document or web page. In one embodiment, when a user prints PDF files or html documents then the internal links (whose target is present in the same file or html page) can be augmented to present the page number and position (in terms of line number etc.) in the page in an augmented format. For example if “xyz” is a link whose target content is present on the bottom page of 10 then on the printout the xyz will be printed as xyz^{(10b)}. The (10b) can appear as superscript of xyz to take less space.

Embodiments of the invention also relate to generating, displaying and printing hyperlinks above external links appearing in a document or web page. External links are links pointing to some external document or web page. For example, if a user is browsing a document containing an external link such as “Adobe Systems Incorporated,” which targets hyperlink http://www.adobe.com, then while printing the document the hyperlink http://www.adobe.com can automatically appear near “Adobe Systems Incorporated” in an augmented format.

Further, embodiments of the invention relate to generating, displaying and printing information relating to an action link appearing in a printed document. Embodiments of the invention help users to identify action links (especially after printing out) on sight, and can supply details about the action link's target. The different colors can be assigned automatically and shown to the user. For example, a simple table can show which color signifies what action, and this information can be given in the printed document at the end of the document or at the bottom or top of a page. The actions can be shown by putting footnotes with the links and giving the description at the bottom of the page.

Other embodiments of the invention may be used in products such as Adobe® Acrobat®. This summary is not intended to describe each embodiment of the invention. The following Detailed Description and Figures provide additional aspects of embodiments of the invention.

### BRIEF DESCRIPTION OF DRAWINGS

FIG. 1 shows an embodiment of a print management system;

FIG. 2 is a flow diagram illustrating embodiments of steps in processing documents which contain internal links or external links; and html documents or web pages containing action links;

FIG. 3 is a screen shot showing embodiments of internal and external links appearing in a document;

FIG. 4 is a screen shot of the page from FIG. 3, wherein the content of the document has been modified in accordance with an embodiment of the invention;

FIG. 5 illustrates an embodiment of an action link related to making a phone call (315) on screen demonstrated by a dialog box (320) displaying the action link.

FIG. 6 illustrates an embodiment of the action link of FIG. 5 printed in gray.

### DETAILED DESCRIPTION OF EMBODIMENTS

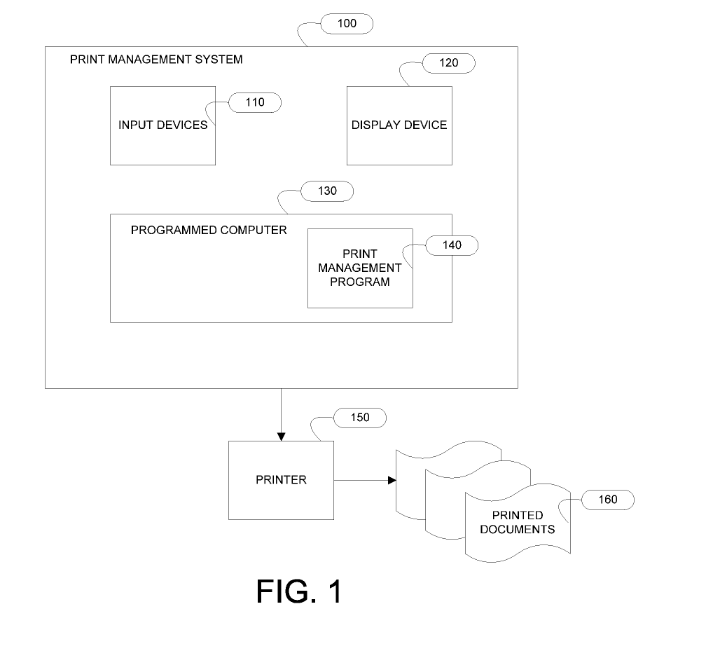

FIG. 1 shows a print management program 140 in an embodiment of the invention running on a computer 130 in a print management system 100. The system typically also has input devices 110 and output devices 120. Print management program 140 enables creating, manipulating, managing, storing and displaying electronic documents 150. Such documents are typically characterized by content information, such as text, images and the like, and can include web pages, PDF documents, electronic books or documents in other conventional formats. Users can use print management program 140 to view and print displayed content. The content management program 140 can be implemented as part of a web browser or a conventional content management program such as Adobe® Acrobat® or Adobe® InDesign®.

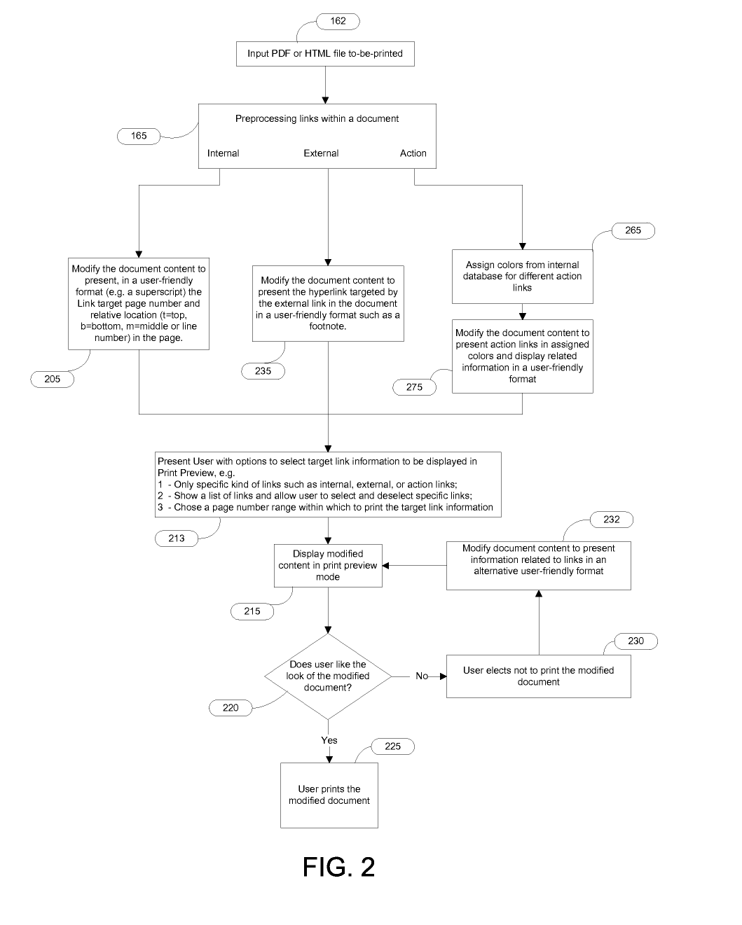

FIG. 2 is a flow diagram illustrating steps of an embodiment of the invention for enhancing links in print-outs with extra information relating to the link in printed form. Step 162 inputs pdf or html file to be printed. Step 165 pre-processes an input to-be-printed PDF document or html file to identify any links. It will be appreciated that pdf and html are only examples, and embodiments of the invention could be used with other document formats. Upon identifying a link, which may be classified as “Internal,” “External” or “Action,” step 165 branches to step 205, 235 or 265 respectively to modify the document content stream to display information related to the link.

For an internal link, step 205 modifies the document content stream to present the target page number and target location on the page, in an augmented format which may be a subscript, superscript, end note, foot note or chapter. The format will contain the page number of the content and the content's relative location (e.g., t=top, b=bottom, m=middle and/or line number) in the destination page. For example, a page near the top of which appears “prior art” as a link might be printed out as “prior art^{(2t)}” with 2t as a superscript to occupy less space on the paper. The “2” is the target page number and the “t” indicates that the target appears near the top of the page.

For an external link, step 235 modifies the content of the document to present the hyperlink targeted by the external link in an augmented format, which may be a subscript, superscript, end note, foot note or chapter. The format will contain the hyperlink to the document targeted by the external link. For example, if a user is browsing a document containing an external link such as “Adobe Systems Incorporated,” which targets hyperlink http://www.adobe.com, then the document can be printed with the hyperlink http://www.adobe.com appearing automatically near “Adobe Systems Incorporated.”

For an action link in an html document or web page, step 265 assigns colors from a prestored color matrix to different action links, possibly as follows:

| | |
|---|---|
| Red | Go to Page View |
| Blue | Import from data |
| Green | Open a file |
| Cyan | Open a web link |
| Violet | Play a sound |
| Brown | Play media |
| Magenta | Read an article |
| Orange | Reset a form |
| Purple | Run a Java script |

Grayscales may also be chosen to represent several different kinds of action links.

Step 275 modifies the content of the document to display action links in their assigned colors and to display information related to the action links in an augmented format, which may be footnotes, end notes, chapter, or a short description at the end of the document.

After either of steps 205, 235 or 275, step 213 offers the user options to selectively print target link information to be displayed in print preview mode. One option may be printing specific kinds of links, such as only internal links, external links, or action links. Another option may be to view a list of all links present in the document from which to select and/or deselect specific links for printing. Another option may be to filter out certain links by using either a page number range or regular expressions.

Step 215 offers the user a “Print Preview” option to view the document with the link modified to show, as the case may be, the target page number and location for an internal link, the hyperlink that the external link is targeting for an external link, or the color for an active link, as they would appear printed on paper. In one embodiment, the user may then save a version of the document in which all of the links are modified to show as the case may be, the target page number and location for an internal link, the hyperlink that the external link is targeting for an external link, or the color for an active link.

In step 220 if the user likes the look of the modified document, he or she may choose step 225 to print the modified document. If the user does not like the look then he or she may decline to print in step 230. Step 232 again modifies the document content to display information related to the action link, this time in an alternative augmented format for the user to preview and possibly adopt. For Action links, step 232 can automatically propose successive colors.

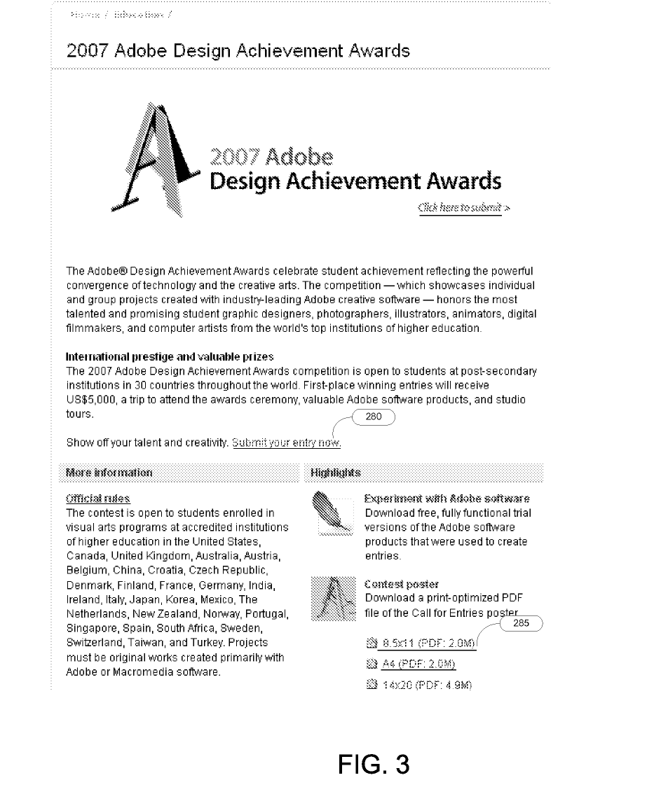

FIG. 3 illustrates internal (280) and external (285) links appearing in a document.

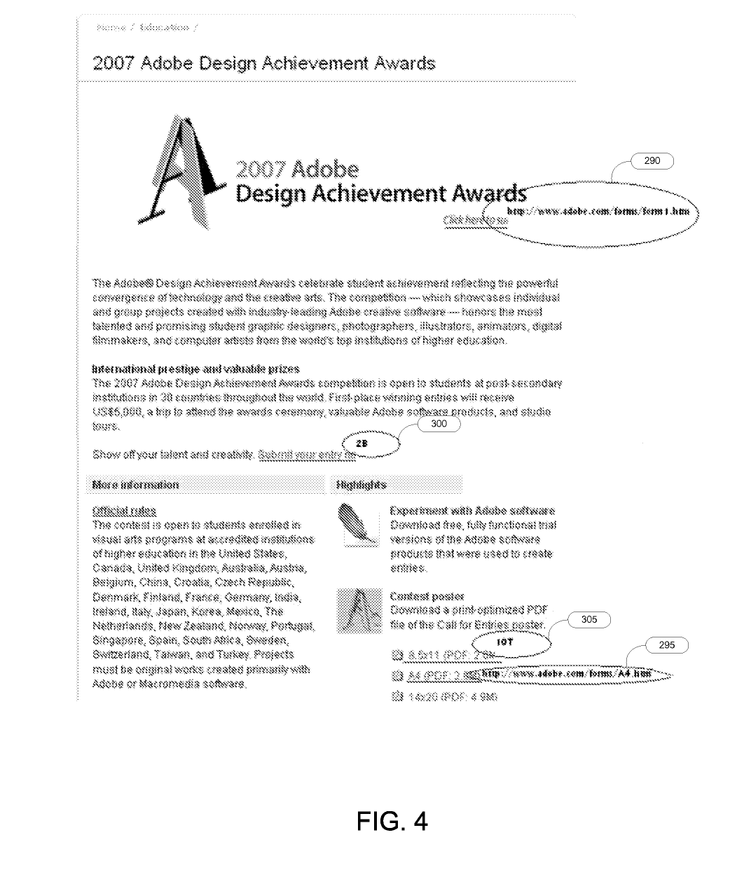

FIG. 4 is a screen shot of the page from FIG. 3, in one embodiments of the invention wherein, the document content has been modified to augment the external links (290, 295) and internal links (300, 305) with the target page number and link location as they will appear in any of a Print Preview mode or a printout form. In an alternative embodiment, FIG.4 illustrates an example of the document content after it has been augmented, and the user can save the document as such for later viewing or printing.

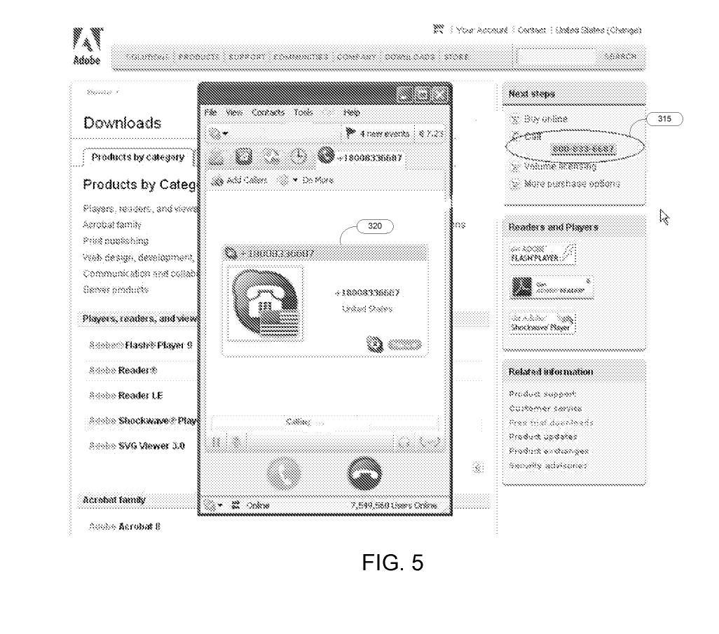

FIG. 5 illustrates an action link related to making a phone call (315) on screen demonstrated by a dialog box (320) displaying the action link.

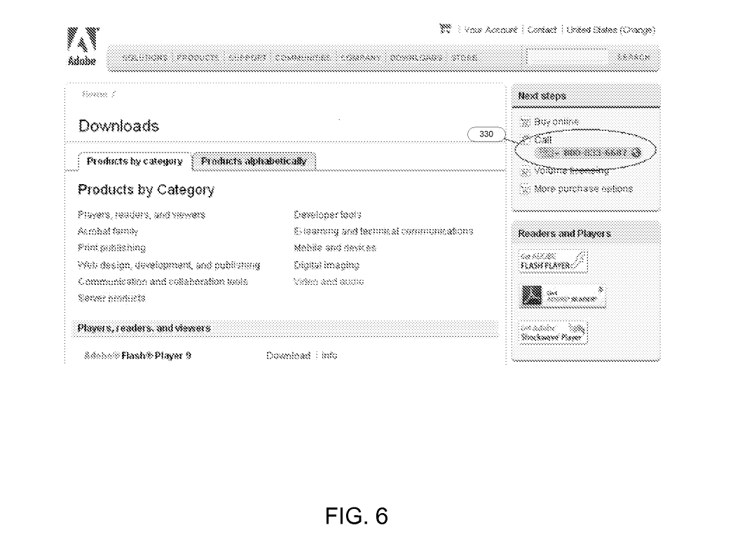

FIG. 6 illustrates the action link of FIG. 5 printed in gray.

Embodiments of the invention can be practiced in digital electronic circuitry, or in computer hardware, firmware, software, in a machine-readable storage device, or in combinations of them. While embodiments of the invention are disclosed in terms of exemplary embodiments, it can be appreciated that it can be practiced in other ways as defined by the scope of the appended claims. Embodiments of the invention can be modified to achieve the goals of generating and printing target page numbers or hyperlinks above links appearing in a document or web page. Embodiments of the invention also allow users to automatically associate different colors with different actions of links, and the color conveys the action information when printed.

1. A computer-implemented method, comprising:
preprocessing a document to find at least one of a plurality of links within the document, wherein said preprocessing comprises identifying at least one non-action link and at least one action link among the plurality of links;
modifying content of the document to include information related to at least some of the plurality of links found within the document in an augmented format, wherein said modifying comprises modifying content corresponding to the at least one non-action link in one augmented format and modifying content corresponding to the at least one action link in a different augmented format; and
displaying said modified document in print preview mode, wherein the modified content corresponding to the at least one non-action link is displayed differently than the modified content corresponding to the at least one action link.

2. The method of claim 1, wherein said non-action link is an internal link.

3. The method of claim 1, wherein said non-action link is an external link.

4. (canceled)

5. The method of claim 1, wherein said one augmented format is selected from the group consisting of a subscript, superscript, a footnote, an end note and combinations thereof

6. The method of claim 1, wherein internal links and external links are designated with different labels.

7. (canceled)

8. The method of claim 1, further comprising, before displaying, receiving a selection of a specific kind of link to be displayed in print preview mode.

9. The method of claim 1, further comprising, before displaying, presenting links present in the document, and receiving a selection or deselection of specific links to be displayed in print preview mode.

10. The method of claim 1, further comprising, before displaying, filtering links to be displayed in print preview mode by either a page number range or regular expressions.

11. The method of claim 1, further comprising printing the modified document.

12. The method of claim 1, further comprising:
assigning a color to said action link, wherein displaying said modified document includes displaying said action link in the assigned color.

13. (canceled)

14. (canceled)

15. The method of claim 4-21, wherein said action link is selected from the group consisting of going to a page view, importing from data, opening a file, playing a sound, play media, reading an article, resetting a form, running a script and combinations thereof

16. The method of claim 1, wherein modifying content of the document modifies content of the document to also display information regarding the nature of the action link in an augmented format.

17. A computer program product, tangibly stored on a machine-readable non-transitory medium, comprising instructions operable to cause a computer to:
preprocess a document to find a plurality of links within the document, wherein said preprocessing comprises identifying at least one non-action link and at least one action link among the plurality of links;
modify content of the document to include information related to at least some of the plurality of links found within the document in an augmented format, wherein said modifying comprises modifying content corresponding to the at least one non-action link in one augmented format and modifying content corresponding to the at least one action link in a different augmented format; and
display said modified document in print preview mode, wherein the modified content corresponding to the at least one non-action link is displayed differently than the modified content corresponding to the at least one action link.

18. A system for generating information related to links in a document, comprising:
a processing module for preprocessing the document for a plurality of links within the document, wherein said preprocessing comprises identifying at least one non-action link and at least one action link among the plurality of links;
a modifier module for modifying content of the document to include information related to at least some of the plurality of links within the document in an augmented format, wherein said modifying comprises modifying content corresponding to the at least one non-action link in one augmented format and modifying content corresponding to the at least one action link in a different augmented format; and
a display device for displaying said modified document in print preview mode, wherein the modified content corresponding to the at least one non-action link is displayed differently than the modified content corresponding to the at least one action link.

19. The method of claim 1, further comprising:
wherein said displaying is in a window of the print preview mode;
receiving user input to the print preview window indicating that the modified document is not acceptable, wherein the indication further indicates to bypass printing;
in response to said user input, modifying the content of the document again to include information related to the same at least some of the plurality of links in an alternative augmented format; and
displaying the again modified document in the window of the print preview mode.

20. The method of claim 1, wherein in response to user input, the method further comprises:
modifying the content of the document again, based on the user input, to include the information related to at least one of the plurality of links in an augmented format that is different from a previous augmented format of that information.

21. The computer program product of claim 17, wherein in response to user input, the instructions are further operable to cause a computer to:
modify the content of the document again, based on the user input, to include the information related to at least one of the plurality of links in an augmented format that is different from a previous augmented format of that information.

22. The system of claim 18, wherein the modifier module is further configured to receive user input and to modify the content of the document again, based on the user input, to include the information related to at least one of the plurality of links in an augmented format that is different from a previous augmented format of that information.
